(19) United States
(12) Patent Application Publication
(10) Pub. No.: US 2014/0088212 A1
(43) Pub. Date: Mar. 27, 2014

(54) SILICONE SURFACTANT FOR MAKING FLEXIBLE FOAMS

(71) Applicant: MOMENTIVE PERFORMANCE MATERIALS, INC., Albany, NY (US)

(72) Inventors: Bright Dai, Shanghai (CN); Hui Huang, Shanghai (CN); Jun Zhang, Shanghai (CN); Roger Christopher Clark, Vienna, WV (US); Paul Edwin Austin, Williamstown, WV (US)

(73) Assignee: Momentive Performance Materials, Inc., Albany, NY (US)

(21) Appl. No.: 13/687,643

(22) Filed: Nov. 28, 2012

(30) Foreign Application Priority Data
Sep. 21, 2012 (CN) 201210353027.X

(51) Int. Cl. C08K 5/5419

(52) U.S. Cl. CPC C08K 5/5419
USPC 521/112

(57) ABSTRACT

A polyurethane foam-forming composition having a surfactant with the formula R¹₃Si(OSiR²G)xOSiR³₃, where each R¹, R², and R³ is independently an alkyl radical having from 1 to 10 carbon atoms; G is a group having the formula —R⁴(OR⁵)_{y}A, where R⁴ is a divalent alkyl radical having from 2 to 4 carbon atoms, R⁵ is ethylene or propylene, A is a hydroxyl group, and x is an number from 1 to 5, and y is an number from 0 to 10 is provided which can be used to form polyurethane foams having a large open cell concentration, improved dry and wet compression sets, and low fugitive emissions.

### CROSS REFERENCE TO RELATED APPLICATIONS

This application claims the benefit under 35 U.S.C. §119 of Chinese Application No. 201210353027.X entitled “Silicone Surfactant For Making Flexible Foams” filed on Sep. 21, 2012, which is hereby incorporated in its entirety by reference.

### FIELD

The present invention relates to polyurethane foam-forming compositions containing a silicone surfactant with a pendent hydroxyl-terminated polyalkene oxide group, polyurethane foams formed from said polyurethane foam-forming compositions and processes for making said polyurethane foams. The present invention provides for a flexible polyurethane foam with greater open cell concentration, better compression sets, and/or low fugitive emissions.

### BACKGROUND

A foam, which is resilience, can be formed by utilizing polyurethane foam-forming compositions incorporating a highly reactive organic polyisocyanate and a high molecular weight polyol having a certain level of primary hydroxyl group content. Such foams are referred to as “high resilience” foams.

High resilience foams have found widespread application as cushioning material in furniture and automotive seating. Most significantly, these foams have been utilized in the automotive industry for making molded auto seats. Many polyurethane foam-forming compositions and processes for making polyurethane foams can be applied to making high resilience foams. However, many of these polyurethane foam-forming compositions and processes do not provide for adequate foam stabilization, which results in the foam collapsing. Due to the highly reactive nature of the reaction mixture from which the high resilience foams are prepared, such foams have been found to exhibit characteristic shrinkage upon demolding and cooling. Additives, which serve to stabilize the polyurethane foam-forming composition as it reacts, foams, and solidifies, are ineffective to prevent shrinkage in high resilience foaming reactions.

Shrinkage in high resilience foams may be due to a large closed cell concentration in the foam block. The presence of closed cells substantially reduces the dimensional stability and flexibility of the foam while increasing its rigidity and brittleness. The preparation of high resilience polyurethane foam is accompanied by the formation of closed cells. The closed cell content of a foam may be reduced by mechanical means, such as crushing or flexing of the foam during its curing process, which causes the closed cells to rupture and open. To avoid foam shrinkage, high resilience foam may be subjected to a crushing process in order to break open the closed cell structure. The Force-to-Crush the foam is an indirect measurement of the foam's closed cell concentration. Crushing can be an expensive timely process in manufacturing high resilience foam.

The extent of formation of closed cells can be minimized in part by the use of cell opening agents (“cell openers”) in preparing the polyurethane foams. The cell openers generally take the form of particles having diameters of about 2 micrometers or smaller. Polymer-polyol, which are produced from ethylenically unsaturated monomers and polyols, as exemplified by the disclosures in U.S. Pat. Nos. 3,383,351; 3,652,639 and 3,823,201, are commonly used cell openers. These polymer-polyols are often mixed with conventional polyether polyols and used as the starting polyol reactant.

A common problem with nearly all conventional cell openers is that they cause deterioration in the foam's mechanical properties, especially compressive strengths. Since these cell openers deteriorate the mechanical properties of the polyurethane foam, it is desirable to reduce or minimize the amount of cell opener used in the polyurethane compositions.

Silicone surfactants have been employed as cell modifiers. These silicone surfactants are polysiloxane containing trimethylsilyloxy, dimethylsilyloxy and pendent polyether-containing silyloxy units. These silicone surfactants often contain cyclic dimethylsiloxanes, which contribute to the fugitive emissions from the polyurethane foam. These foams tend to have high volatile organic compound (VOC) content and exhibit fogging (FOG) behavior.

As such, it is appreciated that there is still a need for a polyurethane foam-forming composition that provides for polyurethane foam with high resilience, low volatile organic compound content, low fogging, greater open cell concentration, and better compression sets.

### SUMMARY

In one aspect, present invention provides a polyurethane foam-forming composition containing a silicone surfactant with a single pendent hydroxy-terminated polyalkene oxide group. The polyurethane foam forming composition can be used for forming high resilience foams. The silicone surfactant with a single pendent hydroxy-terminated polyalkene oxide group provides for foams with a high open cell concentration. Foams made using the compositions can also exhibit improved dry compression sets and wet compression sets. The silicone surfactant with a single pendent hydroxy-terminated polyalkene oxide group also provide a polyurethane foam that has low fugitive siloxane content, which results in foams having low VOC and FOG properties.

In one embodiment, the present invention provides for a polyurethane foam-forming composition comprising:
(a) a polyol;
(b) a polyisocyanate;
(c) a catalyst;
(d) a surfactant having Formula (1):

R¹₃Si(OSiR²G)xOSiR³₃ (1),
wherein:
   each occurrence of R¹, R², and R³ is independently an alkyl radical having from 1 to 10 carbon atoms;
G is an organic group having Formula (2):

—R⁴(OR⁵)_{y}A (2),
where R⁴ is a divalent alkyl radical having from 2 to 4 carbon atoms; R⁵ is ethylene or propylene; A is a hydroxyl group; and the subscript x is a number ranging from 1 to 5; and the subscript y is a number ranging from 0 to 10; and, optionally,
(e) at least one other component selected from the group consisting of a chain extender, a crosslinker, a filler, a reinforcement, a pigment, a tint, a dye, a colorant, a flame retardant, an antioxidant, an antiozonant, a UV stabilizer, an anti-static agent, a biocide and a biostat.

In another embodiment, the present invention provides a method of preparing a flexible polyurethane foam comprising reacting a polyisocyanate with a polyol in the presence of a urethane catalyst and a surfactant, the surfactant having Formula (1):

R¹₃Si(OSiR²G)xOSiR³₃ (1),

wherein:

each R¹, R², and R³ is independently an alkyl radical having from 1 to 10 carbon atoms;

G is a group having Formula (2):

—R⁴(OR⁵)_{y}A (2),

wherein:

R⁴ is a divalent alkyl radical having from 2 to 4 carbon atoms;

R⁵ is ethylene or propylene;

A is a hydroxyl group; and

x is a number from 1 to 5; and

y is a number from 0 to 10.

In one embodiment, R¹, R², and R³ are each a methyl radical.

In one embodiment, R⁵ is ethylene or propylene.

In one embodiment, y is greater than 1, and the surfactant comprises at least one (OR⁵)_{y} group where R⁵ is ethylene, and at least one (OR⁵)_{y} group where R⁵ is propylene.

In one embodiment, the surfactant has a weight average molecular weight of about 2000 or less; in another embodiment, the surfactant has a weight average molecular weight of from about 200 to about 2000; in another embodiment, the surfactant has a weight average molecular weight of from about 200 to about 1000.

In one embodiment, the surfactant is of the formula Me₃Si(OSiMeG)₁OSiMe₃.

In one embodiment, the G group is derived from CH₂═CHCH₂OH; CH₂═CHCH₂(OCH₂CH₂)_{y}OH; CH₂═CHCH₂(OCH₂CHCH₃)OH, or a combination of two or more thereof, where y is 1-10.

In one embodiment, the surfactant (d) is present in an amount of from about 0.01 to about 10 pphp; in another embodiment, the surfactant (d) is present in an amount of from about 0.1 to about 7.5 pphp; in another embodiment, the surfactant (d) is present in an amount of from about 0.20 to about 5 pphp.

In still another embodiment, the present invention provides a polyurethane foame, in one embodiment a flexible foam, formed from the foam-forming composition or the method of preparing a flexible foam. In one embodiment, the polyurethane foam has a siloxane VOC and FOG emission of about 50 ppm or less; about 25 ppm or less; about 10 ppm or less; even about 5 ppm or less.

### DETAILED DESCRIPTION

The present invention provides polyurethane foam-forming compositions containing a silicone surfactant with a pendent hydroxyl-terminated polyalkene oxide group, polyurethane foams formed from said polyurethane foam-forming compositions and processes for making said polyurethane foams. The polyurethane foam-forming compositions containing a silicone surfactant with a pendent hydroxyl-terminated polyalkene oxide group can be used to form flexible, high resilience foam having excellent properties including a high open cell concentration, reduced force-to-crush, dry compression set, wet compression set, low fugitive emissions, or a combination of two or more thereof.

Resilience is defined as the ability to return readily to original shape and dimensions after a deforming force has been applied and removed from a body. In polyurethane foam technology, the industry generally considers “Sag factor” to be the characteristic that differentiates high resilience foams from conventional foams. This Sag factor is a measure of support provided by a cushioning material and is the ratio of indent load deflection (ILD) at 65 percent deflection to that at 25 percent deflection, as measured in accordance with ASTM D-1564-64T. According to SPI standards, conventional, flexible foams exhibit a Sag factor of about 1.7 to 2.2, while high resilience foams display a Sag factor of above about 2.2 to about 3.2.

The present invention provides a polyurethane foam-forming composition comprising:
(a) a polyol;
(b) a polyisocyanate;
(c) a catalyst;
(d) a surfactant having Formula (1):

R¹₃Si(OSiR²G)xOSiR³₃,
wherein:
   each occurrence of R¹, R², and R³ is independently an alkyl radical having from 1 to 10 carbon atoms;
   G is an organic group having Formula (2):

—R⁴(OR⁵)_{y}A,
wherein R⁴ is a divalent alkyl radical having from 2 to 4 carbon atoms; R⁵ is ethylene or propylene; A is a hydroxyl group; and the subscript x is a number ranging from 1 to 5; and the subscript y is a number ranging from 0 to 10; and, optionally,
(e) at least one other component selected from the group consisting of a chain extender, a crosslinker, a filler, a reinforcement, a pigment, a tint, a dye, a colorant, a flame retardant, an antioxidant, an antiozonant, a UV stabilizer, an anti-static agent, a biocide and a biostat.

The surfactant (d) for the foam-forming composition and in accordance with the present invention is a low molecular weight siloxane copolymer comprising hydroxyl capped polyoxyalkylene pendant groups.

Representative and non-limiting examples of the surfactant (d) with a pendent hydroxyl-terminated polyalkene oxide group include: 3-[bis-(trimethoxysilyloxy)-methyl-silanyl]-propan-1-ol; 2-{3-[bis-(trimethylsilyloxy)-methyl-silanyl]-propoxy}-ethanol; 2-{3-[bis-(trimethylsilyloxy)-methyl-silanyl]-propoxy}-propan-2-ol; 2-(2-{3-[bis-(trimethylsilyloxy)-methyl-silanyl]-propoxy}-ethoxy)-ethanol; 2-[2-(2-{3-[bis-(trimethylsilyloxy)-methyl-silanyl]-propoxy}-ethoxy)-ethoxy]-ethanol; 2-{2-[2-(2-{3-[bis-(trimethylsilyloxy)-methyl-silanyl]-propoxy}-ethoxy)-ethoxy]-ethoxy}-ethanol; 2-{3-[bis-(trimethylsilyloxy)-methyl-silanyl]-propoxy}-1-methyl-ethanol; 2-(2-{3-[bis-(trimethylsilyloxy)-methyl-silanyl]-propoxy}-1-methyl-ethoxy)-ethanol; 2-[2-(2-{3-[bis-(trimethylsilyloxy)-methyl-silanyl]-propoxy}-1-methyl-ethoxy)-ethoxy]-ethanol; 2-[2-(2-{3-[bis-(trimethylsilyloxy)-methyl-silanyl]-propoxy}-1-methyl-ethoxy)-ethoxy]-propan-2-ol; 2-{2-[2-(2-{3-[bis-(trimethylsilyloxy)-methyl-silanyl]-propoxy}-1-methyl-ethoxy)-1-methyl-ethoxy]-1-methyl-1-ethoxy}-ethanol; and mixtures thereof.

In one embodiment, the surfactants (d) are substantially free of pendant groups where the polyoxyalkylene group is capped by a hydrocarbon.

In one embodiment, the surfactant (d) has Formula (1):

R¹₃Si(OSiR²G)xOSiR³₃ (1),

wherein:

each occurrence of R¹, R², and R³ is independently an alkyl radical having from 1 to 10 carbon atoms;

G is an organic group having Formula (2):

—R⁴(OR⁵)_{y}A (2),

where R⁴ is a divalent alkyl radical having from 2 to 4 carbon atoms;
R⁵ is ethylene or propylene; A is a hydroxyl group; and the subscript x is a number ranging from 1 to 5; and the subscript y is a number ranging from 0 to 10;

In another embodiment, each R¹, R², and R³ is independently selected from an alkyl radical having from 1 to 3 carbon atoms.

In yet another embodiment, R¹, R², and R³ are methyl radicals.

In still yet another embodiment, R⁴ is an alkylene group having from 3 to 5 carbon atoms, R⁵ is an alkylene group having 2 to 5 carbon atoms, and preferably, R⁵ is 1,2-ethylene or 1,2-propylene.

In particular, the surfactant (d) is a silicone polyether copolymer of the Formula (3):

Me₃Si(OSiMeG)xOSiMe₃ (2)

where Me is methyl, G has the formula —R⁴(OR⁵)_{y}A, where R⁴ is a divalent radical having from 2 to 4 carbon atoms, R⁵ is 1,2-ethylene or 1,2-propylene, A is a hydroxyl group; and x is 1 to 5; and y is 0-10.

The G group can include both ethylene oxide and propylene oxide groups. Thus, where y is greater than 1, the G group can include one or more ethylene oxide units and one or more propylene oxide units. The value y can be any integer from 0 to 10 or an average value thereof. In one embodiment, the G group is derived from CH₂═CHCH₂OH; CH₂═CHCH₂(OCH₂CH₂)_{y}OH; CH₂═CHCH₂(OCH₂CHCH₃)_{y}OH, or a combination of two or more thereof, where y is from 1 to 10.

Representative and non-limiting examples of G groups are organic group derived from allyl containing alcohols, such as CH₂═CHCH₂OH; CH₂═CHCH₂O(CH₂CH₂O)_{1.0}H; CH₂═CHCH₂O(CH₂CH₂O)_{3.45}H; CH₂═CHCH₂O(CH₂CH₂O)_{3.5}H; CH₂═CHCH₂O(CH₂CH₂O)_{7.5}H; CH₂═CHCH₂O(CH₂CHCH₃O)_{3.76}H; CH₂═CHCH₂O(CH₂CHCH₃O)₁OH, and mixtures thereof.

The surfactant (d) can have a polyalkylene oxide group derived from ethylene oxide and/or a propylene oxide. In one embodiment, the hydroxy-terminated polyalkylene oxide group of the surfactant (d) has from about 0 to 10 ethylene oxide groups, more particularly from about 2 to 8 ethylene oxide groups, even more particularly from about 3 to 7 ethylene oxide groups and still more particularly from about 4 to 6 ethylene oxide groups.

In another embodiment, the surfactant (d) has a hydroxy-terminated polyalkylene oxide group containing from about 0 to 10 propylene oxide groups, more particularly from about 2 to 8 propylene oxide groups, even more particularly from about 3 to 7 propylene oxide groups, still even more particularly from about 4 to 6 propylene oxide groups.

The inventors have found that if the present surfactant has greater than 10 alkylene oxide units, and particularly greater than 10 propylene oxide units, the foam will tend to collapse.

The surfactant (d) has a weight average molecular weight of about 2000 or less, more particularly, from about 200 to about 2000, and even more particularly of from about 200 to about 1000.

The surfactant (d) can be used in the polyurethane foam-forming compositions at a concentration of from about 0.01 to about 10 pphp, more particularly in an amount of from about 0.1 to about 7.5 pphp and even more particularly in an amount of from about 0.20 to about 5 pphp, were pphp means parts per hundred parts polyol.

The surfactant (d) can be provided as a surfactant composition comprising the surfactant (d) and a diluent. The concentration of the surfactant in the surfactant composition can be selected as desired for a particular purpose or intended use. In one embodiment, the surfactant concentration in the surfactant composition can be from about 10% to about 50% by weight of the surfactant composition, more particularly from about 15% to about 75%, and even more particularly from about 20% to about 50% by weight, based upon the weight of the surfactant composition.

The diluent may be a mono-, di-, or triol of a polyether, a low molecular weight glycol, or a nonionic surfactant. Diluents generally have substantially no effect on the surfactant properties of the surfactant composition, but can be a material that is chemically reactive in the polyurethane foam composition in which the surfactant composition is ultimately used. Suitable diluents include, but are not limited to, materials such as polyethers containing ethylene oxide and propylene oxide units and at least one hydroxyl group.

Representative and non-limiting examples of diluents include dipropylene glycol, ethoxylated nonyl phenols, and a butyl alcohol started polyether containing ethylene oxide and propylene oxide units, especially butyl alcohol started polyether containing about 50 mole % ethylene oxide units.

According to an embodiment, the polyurethane foam-forming composition is directed to preparation of high resilience flexible polyurethane foam. High resilience (HR) foam is widely used for furniture cushions, mattresses, automotive cushions and padding, and numerous other applications requiring better support and comfort. HR foam is differentiated from conventional foam by its higher comfort or support factor and higher resilience. HR foam also is usually produced using low water levels to provide higher foam densities, typically above 20 kg/m³ and often above 40 kg/m³. The present invention is also useful in conventional foams, which have densities as low as 15 kg/m³, and for the most part below about 40 kg/m³.

According to another embodiment of the invention the polyurethane foam-forming composition is directed to preparation of a viscoelastic polyurethane foam. Viscoelastic polyurethane foam (also known as “dead” foam, “slow recovery” foam, or “high damping” foam) is characterized by slow, gradual recovery from compression. While most of the physical properties of viscoelastic polyurethane foams resemble those of conventional foams, the density gradient of viscoelastic polyurethane foam is much poorer. To manufacture a viscoelastic polyurethane foam, it is often desirable to use a “viscoelastic polyol.” A viscoelastic polyol is characterized by high hydroxyl number (OH) and tends to produce shorter chain polyurethane blocks with a glass transition temperature of the resulting foam near to room temperature.

The polyol (a) component can be any polyol useful to form a polyurethane foam and particularly for forming high resilience foam. The polyol is normally a liquid polymer possessing hydroxyl groups. The term “polyol” includes linear and branched polyethers (having ether linkages), polyesters and blends thereof, and comprising at least two hydroxyl groups. In one embodiment, the polyol can be at least one of the types generally used to prepare polyurethane foams. A polyether polyol having a weight average molecular weight of from about 150 to about 10,000 is particularly useful.

Polyols containing reactive hydrogen atoms generally employed in the production of high-resilience polyurethane foams can be employed in the formulations of the present invention. The polyols are hydroxy-functional chemicals or polymers covering a wide range of compositions of varying molecular weights and hydroxy functionality. These polyhydroxyl compounds are generally mixtures of several components although pure polyhydroxyl compounds, i.e. individual compounds, can in principle be used.

Representative polyols include, but are not limited to, polyether polyols, polyester polyols, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, and polycarbonate polyols, polyoxypropylene polyether polyol, mixed poly(oxyethylene/oxypropylene)polyether polyol, polybutadienediols, polyoxyalkylene diols, polyoxyalkylene triols, polytetramethylene glycols, polycaprolactone diols and triols, all of which possess at least two primary hydroxyl groups.

Some specific, non-limiting examples of polyether polyols include, polyoxyalkylene polyol, particularly linear and branched poly(oxyethylene)glycol, poly(oxypropylene)glycol, copolymers of the same and combinations thereof. Non-limiting examples of modified polyether polyols include polyoxypropylene polyether polyol into which is dispersed poly(styrene acrylonitrile) or polyurea, and poly(oxyethylene/oxypropylene)polyether polyols into which is dispersed poly(styrene acrylonitrile) or polyurea.

In one embodiment the polyether polyol is chosen from ARCOL® polyol 1053, Arcol E-743, Hyperlite® E-848 from Bayer AG, Voranol® from Dow BASF, Stepanpol®. from Stepan, Terate® from Invista, or combinations of two or more thereof.

Graft or modified polyether polyols comprise dispersed polymeric solids.

Suitable polyesters include, but are not limited to, aromatic polyester polyols such as those made with pthallic anhydride (PA), dimethlyterapthalate (DMT) polyethyleneterapthalate (PET) and aliphatic polyesters, and the like.

Other non-limiting examples of suitable polyols include those derived from propylene oxide and ethylene oxide and an organic initiator or mixture of initiators of alkylene oxide polymerization and combinations thereof.

The hydroxyl number of a polyol is the number of milligrams of potassium hydroxide required for the complete hydrolysis of the fully acylated derivative prepared from one gram of polyol. The hydroxyl number is also defined by the following equation, which reflects its relationship with the functionality and molecular weight of the polyol:

OH No.=(56.1×1000×f)/M.W.

wherein OH=hydroxyl number of the polyol; f=average functionality, that is, average number of hydroxyl groups per molecule of the polyether polyol; and M.W.=number average molecular weight of the polyether polyol. The average number of hydroxyl groups in the polyether polyol is achieved by control of the functionality of the initiator or mixture of initiators used in producing the polyether polyol.

In one embodiment, the polyol can have a functionality of from about 2 to about 12, and in another embodiment of the present invention, the polyol has a functionality of at least 2. It will be understood by a person skilled in the art that these ranges include all subranges there between.

In one embodiment, the polyurethane foam-forming composition comprises a polyether polyol having a hydroxyl number of from about 10 to about 3000, more particularly from about 20 to about 2000 even more particularly from about 30 to about 1000 and still even more particularly from about 35 to about 800. Here as elsewhere in the specification and claims, numerical values can be combined to form new and non-disclosed ranges.

The polyisocyanate (b) can include any organic compound contain at least two isocyanate groups that can be used for production of polyurethane foam. In one embodiment, the polyisocyanate can be an organic compound that comprises at least two isocyanate groups and generally will be any known or later discovered aromatic or aliphatic polyisocyanates.

In one embodiment, the polyisocyanate can be a hydrocarbon diisocyanate, including alkylenediisocyanate and arylene diisocyanate.

Representative and non-limiting examples of polyisocyanates include toluene diisocyanate, diphenylmethane isocyanate, polymeric versions of toluene diisocyanate and diphenylmethane isocyanate, methylene diphenyl diisocyanate (MDI), 2,4- and 2,6-toluene diisocyanate (TDI), triisocyanates and polymethylene poly(phenylene isocyanates) also known as polymeric or crude MDI and combinations thereof. Commercial available 2,4- and 2,6-toluene diisocyanates include Mondur® TDI.

In one embodiment, the polyisocyanate can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture. It will be understood by a person skilled in the art that these ranges include all subranges there between.

The amount of polyisocyanate included in the polyurethane foam-forming composition relative to the amount of other materials in polyurethane foam-forming composition is described in terms of “Isocyanate Index.” “Isocyanate Index” means the actual amount of polyisocyanate used divided by the theoretically required stoichiometric amount of polyisocyanate required to react with all active hydrogen in polyurethane foam-forming composition multiplied by one hundred (100).

In one embodiment, the Isocyanate Index in the polyurethane foam-forming composition is from about 60 to about 300, more particularly from about 70 to about 200, even more particularly from about 80 to about 120. It will be understood by a person skilled in the art that these ranges include all subranges there between.

The catalyst (c) for the production of the polyurethane foams herein can be a single catalyst or mixture of catalysts that can be used to catalyze the reactions of polyol and water with polyisocyanates to form polyurethane foam. It is common, but not required, to use both an organoamine and an organotin compound for this purpose. Other metal catalysts can be used in place of, or in addition to, organotin compound.

Representative and non-limiting examples of catalyst (c) includes
(i) tertiary amines such as bis(2,2′-dimethylamino)ethyl ether, trimethylamine, triethylenediamine, 1,8-diazabicyclo[5.4.0]undec-7-ene, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino}ethanol, pyridine oxide, and the like;
(ii) strong bases such as alkali and alkaline earth metal hydroxides, alkoxides, phenoxides, and the like;
(iii) acidic metal salts of strong acids such as ferric chloride, stannous chloride, antimony trichloride, bismuth nitrate and chloride, and the like;
(iv) chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with various metals such as Be, Mg, Zn, Cd, Pb, Ti, Zr, Sn, As, Bi, Cr, Mo, Mn, Fe, Co, Ni, or such ions as MoO₂++, UO₂++, and the like;
(v) alcoholates and phenolates of various metals such as Ti(OR)₄, Sn(OR)₄, Sn(OR)₂, Al(OR)₃, and the like, wherein R is alkyl or aryl of from 1 to about 12 carbon atoms, and reaction products of alcoholates with carboxylic acids, beta-diketones, and 2-(N,N-dialkylamino)alkanols, such as well known chelates of titanium obtained by this or equivalent procedures;
(vi) salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like;
(vii) organometallic derivatives of tetravalent tin, trivalent and pentavalent As, Sb, and Bi, and metal carbonyls of iron and cobalt;
   and combinations thereof.

In one embodiment, the catalyst (c) is organotin compounds that are dialkyltin salts of carboxylic acids, including the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations of two or more thereof.

Similarly, in another embodiment there may be used trialkyltin hydroxide, dialkyltin oxide, dialkyltin dialkoxide, or dialkyltin dichloride, and combinations of two or more thereof can be employed. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide)dibutyltin-bis(2-dimethylaminopentylate), dibutyltin dichloride, dioctyltin dichloride, and the like, and combinations of two or more thereof.

In one embodiment, the catalyst can be an organotin catalyst such as stannous octoate, dibutyltin dilaurate, dibutyltin diacetate, stannous oleate, or combinations of two or more thereof. In another embodiment, the catalyst can be an organoamine catalyst, for example, tertiary amine such as trimethylamine, triethylamine, triethylenediamine, bis(2,2-dimethylamino)ethyl ether, N-ethylmorpholine, diethylenetriamine, 1,8-diazabicyclo[5.4.0]undec-7-ene, or combinations of two or more thereof. In still another embodiment, the catalyst can include mixtures of tertiary amine and glycol, such as Niax® catalyst C-183 (Momentive Performance Materials, Inc.), stannous octoate, such as Niax® catalyst D-19 (Momentive Performance Materials, Inc.), or combinations of two or more thereof.

According to one embodiment of the present invention, the catalyst is an amine catalyst for the production of high resilience flexible slabstock and molded foams. These amine catalysts can be bis(N,N-dimethylaminoethyl)ether or 1,4-diazabicyclo[2.2.2]octane.

In another embodiment amine catalysts can include mixtures of tertiary amine and glycol, such as Niax® catalyst C-183, stannous octoate, such as Niax® catalyst D-19 and combinations thereof, all available from Momentive Performance Materials.

The polyurethane foam-forming composition can include other components (e), such as a blowing agent. The blowing agent can be one blowing agent of the physical and/or chemical type. Typical physical blowing agents include, but are not limited to methylene chloride, acetone, water or CO₂, which are used to provide expansion in the foaming process. A typical chemical blowing agent is water, which reacts with isocyanates in the foam, forming reaction mixture to produce carbon dioxide gas. These blowing agents possess varying levels of solubility or compatibility with the other components used in the formation of polyurethane foams. Developing and maintaining a good emulsification when using components with poor compatibility is critical to processing and achieving acceptable polyurethane foam quality.

Other components (e), such as additives, can be added to polyurethane foam to impart specific properties to polyurethane foam. Examples of other suitable additives include, but not limited to, fire retardant, stabilizer, coloring agent, filler, anti-bacterial agent, extender oil, anti-static agent, solvent and combinations thereof.

Methods for producing polyurethane foam from the polyurethane foam-forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used. For example, the composition of the present invention can be prepared by combining the polyols, amine catalyst, surfactants, blowing agent, and additional compounds including optional ingredients into a premix. This polyol blend is added to and mixed with the isocyanate.

### EXAMPLES

### Silicone Surfactants

### Example 1

A well stirred mixture of 50.05 grams of an olefinically substituted polyoxyalkylene having the average formula CH₂═CHCH₂OH, 29.99 grams of an organohydrogen polysiloxane having the average formula Me₃SiO(MeHSiO)₁SiMe₃ and nitrogen is slightly sparged. The flask is heated to 70° C. A solution of H₂PtCl₆.6H2O in ethanol is added to the mixture in a sufficient amount to provide 10 ppm Pt. The heat source is removed and the exothermic hydrosilation reaction is allowed to proceed until no further temperature increase is noted. When the maximum temperature rises to 95° C., 119.96 grams of Me₃SiO(MeHSiO)₁SiMe₃ is added drop wise into the flask. The maximum temperature rises to 105° C. and the flask is allowed to maintain this temperature for 1.5 hours. The residual SiH content is measured and observed to be below 0.1 g/cc, which means the hydrosilation reaction is complete. The copolymer is allowed to cool down to 25° C. and is filtered.

### Example 2

A well stirred mixture of 74.33 grams of an olefinically substituted polyoxyalkylene having the average formula CH₂═CHCH₂O(CH₂CH₂O)_{1.0}H, 25.13 grams of an organohydrogen polysiloxane having the average formula Me₃SiO(MeHSiO)₁SiMe₃ and nitrogen is slightly sparged. The flask is heated to 70° C. A solution of H₂PtCl₆.6H2O in ethanol is added to the mixture in a sufficient amount to provide 10 ppm Pt. The heat source is removed and the exothermic hydrosilation reaction is allowed to proceed until no further temperature increase is noted. The maximum temperature rises to 95° C. and 100.54 grams of Me₃SiO(MeHSiO)₁SiMe₃ is added drop wise into the flask. The maximum temperature rises up to 105° C. and the mixture is allowed to agitate for an additional 1.5 hours. The SiH content is measured and it is below 0.1 g/cc, which means the hydrosilation reaction is completed. The mixture is allowed to cool and cooled the copolymer down to 25° C. and is filtered.

### Example 3

A well stirred mixture of 110 grams of an olefinically substituted polyoxyalkylene having the average formula CH₂═CHCH₂O(CH₂CH₂O)_{3.45}H, 18 grams of an organohydrogen polysiloxane having the average formula Me₃SiO(MeHSiO)₁SiMe₃ and nitrogen is slightly sparged. The flask is heated to 80° C. A solution of H₂PtCl₆.6H2O in ethanol is added to the mixture in a sufficient amount to provide 10 ppm Pt. The heat source is removed and the exothermic hydrosilation reaction is allowed to proceed until no further temperature increase is noted. The maximum temperature rises up to 95° C. and 72 grams of Me₃SiO(MeHSiO)₁SiMe₃ is added drop wise into the flask. The temperature rises up to 105° C. and the reaction is kept to agitate for 1.5 hours. The SiH is measured and is below 0.1 g/cc, which means the hydrosilation reaction is completed and the copolymer is cooled down to 25° C. and filtered.

### Example 4

A well stirred mixture of 110.54 grams of an olefinically substituted polyoxyalkylene having the average formula CH₂═CHCH₂O(CH₂CH₂O)_{3.5}H, 17.89 grams of an organohydrogen polysiloxane having the average formula Me₃SiO(MeHSiO)₁SiMe₃ and nitrogen is slightly sparged. The flask is heated to 75° C. A solution of H₂PtCl₆.6H2O in ethanol is added to the mixture in sufficient amount to provide 10 ppm Pt. The heat source is removed and the exothermic hydrosilation reaction is allowed to proceed until no further temperature increase was noted. The maximum temperature increases to 95° C. wherein 71.57 grams of Me₃SiO(MeHSiO)₁SiMe₃ is added drop wise into the flask. The maximum temperature rises up to 105° C. and the reaction is agitated for 1.5 hours. SiH is measured and below 0.1 g/cc, which means the hydrosilation reaction is completed, and the copolymer is cooled down to 25° C. and filtered.

### Example 5

A well stirred mixture of 138.77 grams of an olefinically substituted polyoxyalkylene having the average formula CH₂═CHCH₂O(CH₂CH₂O)_{7.5}H, 12.25 grams of an organohydrogen polysiloxane having the average formula Me₃SiO(MeHSiO)₁SiMe₃ and nitrogen is slightly sparged. The flask is heated to 80° C. A solution of H₂PtCl₆.6H2O in ethanol is added to the mixture in a sufficient amount to provide 10 ppm Pt. The heat source is removed and the exothermic hydrosilation reaction is allowed to proceed until no further temperature increase is noted. The maximum temperature rises up to 95° C. and 48.99 grams of Me₃SiO(MeHSiO)₁SiMe₃ is added drop wise into the flask. The max temperature rises up to 105° C. and the reaction is agitated for 1.5 hours. SiH is measured and is below 0.1 g/cc, which means the hydrosilation reaction is completed and the copolymer is cooled down to 25° C. and filtered.

### Example 6

A well stirred mixture of 123.40 grams of an olefinically substituted polyoxyalkylene having the average formula CH₂═CHCH₂O(CH₂CHCH₃O)_{3.76}H, 15.29 grams of an organohydrogen polysiloxane having the average formula Me₃SiO(MeHSiO)₁SiMe₃ and nitrogen is slightly sparged. The flask is heated to 70° C. A solution of H₂PtCl₆.6H2O in ethanol is added to the mixture in sufficient amount to provide 10 ppm Pt. The heat source is removed and the exothermic hydrosilation reaction is allowed to proceed until no further temperature increase is noted. The maximum temperature rises up to 95° C. and 61.16 grams of Me₃SiO(MeHSiO)₁SiMe₃ is added drop wise into the flask. The max temperature rises up to 105° C. and the reaction is agitated for 1.5 hours. SiH is measured and is below 0.1 g/cc, which means the hydrosilation reaction is completed, and the copolymer is cooled down to 25° C. and filtered.

### Example 7

A well stirred mixture of 157.77 grams of an olefinically substituted polyoxyalkylene having the average formula CH₂═CHCH₂O(CH₂CHCH₃O)₁₀H, 8.45 grams of an organohydrogen polysiloxane having the average formula Me₃SiO(MeHSiO)₁SiMe₃ and nitrogen is slightly sparged. The flask is heated to 80° C. A solution of H₂PtCl₆.6H2O in ethanol is added to the mixture in sufficient amount to provide 10 ppm Pt. The heat source is removed and the exothermic hydrosilation reaction is allowed to proceed until no further temperature increase is noted. The maximum temperature rises up to 95° C. wherein 33.78 grams of Me₃SiO(MeHSiO)₁SiMe₃ is added drop wise into the flask. The maximum temperature rises up to 105° C., and the reaction is kept for 1.5 hours. SiH is measured and is below 0.1 g/cc, which means the hydrosilation reaction is completed, and the copolymer is cooled down to 25° C. and filtered.

### Surfactant Compositions

### Examples 8 to 14

The surfactants from Examples 1 through 7 are mixed with a diluent to form Surfactant Compositions S1-S7. The diluent in the compositions S1-S7 is a butyl alcohol started propylene oxide. The compositions are illustrated in Table 1.

TABLE 1

| | Ex. | Ex. | Ex. | Ex. | Ex. | Ex. | Ex. | dil- |
|---|---|---|---|---|---|---|---|---|
| Sur- | 8 | 9 | 10 | 11 | 12 | 13 | 14 | uent |
| factant | [%] | [%] | [%] | [%] | [%] | [%] | [%] | [%] |
| S1 | 25 | | | | | | | 75 |
| S2 | | 25 | | | | | | 75 |
| S3 | | | 25 | | | | | 75 |
| S4 | | | | 25 | | | | 75 |
| S5 | | | | | 25 | | | 75 |
| S6 | | | | | | 25 | | 75 |
| S7 | | | | | | | 25 | 75 |

### Polyurethane Foam-Forming Compositions

### Examples 15 to 28 and Comparative Example I and II

The surfactant compositions S1-S7 are employed in foam forming compositions. The foam compositions include the surfactants S1-S7 at concentrations of 0.5 pphp, 1.0 pphp, or 1.5 pphp. Comparative examples I and II employ Niax* Silicone L-3002 as the surfactant, which is a silicone available from Momentive Performance Materials. Table 2 illustrates the composition of the polyurethane foam-forming composition.

TABLE 2

| | php | Batch, grams |
|---|---|---|
| Polyether Polyol | 70 | 1820 |
| 330N(OH = 35) | | |
| Polymer of Polyol | 30 | 780 |
| 3628(OH = 27) | | |
| DEOA | 1.2 | 31.2 |
| Water(Added) | 3.8 | 98.8 |
| Niax* Catalyst A-400 | 0.11 | 2.86 |
| Niax* Catalyst A-33 | 0.44 | 11.44 |
| Cell Opener (S240) | 2 | 52 |
| Surfactant L-3002 or S1-S7 | 0.5, 1 or 1.5 | |
| Modified MDI 3133(I = 95) | 59.61 | |

### Foams

Polyurethane foams are produced according to the following process. The formulation presented in Table 2 is a hand-mix high resilience flexible polyurethane molded foam-forming formulation prepared according to the following procedure: All foaming components, except isocyanate, are weighed into a paper cup and mixed for 30 seconds at 4000 rpm with a large mixing blade. Isocyanate is weighed into a separated container, added to the mixture previously described and mixed for an additional 6 seconds at 4000 rpm. The foam-forming composition is poured into a 300 mm×300 mm×100 mm square mold contained at a temperature of 50° C. After 5 minutes, the foams are demolded. After 1 minute, the foam Force-to-Crush is measured using a Zwick Materials Testing machine according to ASTM D-3574.

Wet compression set and dry compression set of the foams are measured using ASTM D-3574. Foam samples are cut into the piece with 25 mm height, 50 mm width and 50 mm length, which are compressed at 50% of the original height by a steeliness panel. Measure the original height of the foam sample and record it into H1. The steeliness panel with compressed foams is placed in the oven with 70 C for 22 hours. After oven cure, the foam samples are uncompressed and placed in the room temperature for 30 minutes. Sample height is measured again and recorded as H2. The dry compression set ═(H1−H2)/H1*100. For the wet compression set is same test method, and the difference is the samples which are traded in 70 C, 95% humid for 22 hours.

Tables 3 and 4 illustrate various properties of the foams prepared using foaming forming compositions employing the surfactants in amounts of 0.5 php and 1.5 php, respectively:

TABLE 3

| | | | Force to | Dry | Wet |
|---|---|---|---|---|---|
| Ex | | Surfactant | Crush | Compresion | Comperssion |
| No | Surfactant | Concentration | (N) | Set (%) | Set (%) |
| I | L-3002 | 0.5 | 2807 | 8.0 | 14.4 |
| 15 | S1 | 0.5 | 2679 | 7.4 | 13.6 |
| 16 | S2 | 0.5 | 2552 | 7.4 | 13.0 |
| 17 | S3 | 0.5 | 2645 | 7.1 | 12.8 |
| 18 | S4 | 0.5 | 2660 | 7.0 | 12.6 |
| 19 | S5 | 0.5 | 2266 | 7.6 | 13.4 |
| 20 | S6 | 0.5 | 2689 | 7.4 | 13.0 |
| 21 | S7 | 0.5 | 2597 | 7.0 | 12.4 |

TABLE 4

| | | | Force to | Dry | Wet |
|---|---|---|---|---|---|
| Ex | | Surfactant | Crush | Compresion | Comperssion |
| No | Surfactant | Concentration | (N) | Set (%) | Set (%) |
| II | L-3002 | 1.5 | 2642 | 7.1 | 16.9 |
| 22 | S1 | 1.5 | 2383 | 5.7 | 15.4 |
| 23 | S2 | 1.5 | 2489 | 6.7 | 15.8 |
| 24 | S3 | 1.5 | 2521 | 6.3 | 15.5 |
| 25 | S4 | 1.5 | 2544 | 6.4 | 15.8 |
| 26 | S5 | 1.5 | 2456 | 5.8 | 13.2 |
| 27 | S6 | 1.5 | 2464 | 6.4 | 15.5 |
| 28 | S7 | 1.5 | 2545 | 6.2 | 15.5 |

### Example 29 and Comparative Example III

The fugitive emissions of the foam are evaluated by using VDA278. Table 5 illustrates the VOC and FOG values of a foam in accordance with aspects of the invention against the comparative surfactant.

TABLE 5

| Ex. | | Surfactant | Siloxane VOC | Siloxane FOG |
|---|---|---|---|---|
| No. | Surfactant | Concentration | (ppm) | (ppm) |
| III | Niax1 | 0.5 | 209 | 160 |
| 29 | S3 | 0.5 | 3 | 0 |

¹Niax* Silicone L-3002

The foregoing description identifies various, non-limiting embodiments of surfactants, polyurethane foam-forming compositions comprising such surfactants, and foams made therefrom in accordance with aspects of the present invention. Modifications may occur to those skilled in the art and to those who may make and use the invention. The disclosed embodiments are merely for illustrative purposes and not intended to limit the scope of the invention or the subject matter set forth in the following claims.

What is claimed is:

1. A polyurethane foam-forming composition comprising:
(a) a polyol;
(b) a polyisocyanate;
(c) a catalyst;
(d) a surfactant having Formula (1):
R¹³Si(OSiR²G)xOSiR³₃ (1),
wherein:
each occurrence of R¹, R², and R³ is independently an alkyl radical having from 1 to 10 carbon atoms;
G is an organic group having Formula (2):
—R⁴(OR⁵)_{y}A (2),
where R⁴ is a divalent alkyl radical having from 2 to 4 carbon atoms; R⁵ is ethylene or propylene; A is a hydroxyl group; and the subscript x is a number ranging from 1 to 5; and the subscript y is a number ranging from 0 to 10; and, optionally,
(e) at least one other component selected from the group consisting of a chain extender, a crosslinker, a filler, a reinforcement, a pigment, a tint, a dye, a colorant, a flame retardant, an antioxidant, an antiozonant, a UV stabilizer, an anti-static agent, a biocide and a biostat.

2. The polyurethane foam-forming composition of claim 1, wherein R¹, R², and R³ are each a methyl radical.

3. The polyurethane foam-forming composition of claim 1, wherein R⁵ is ethylene.

4. The polyurethane foam-forming composition of claim 1, wherein R⁵ is propylene.

5. The polyurethane foam-forming composition of claim 1, wherein y is greater than 1, and the surfactant comprises at least one (OR⁵)_{y} group where R⁵ is ethylene, and at least one (OR⁵)_{y} group where R⁵ is propylene.

6. The polyurethane foam-forming composition of claim 1, wherein the surfactant has a weight average molecular weight of about 2000 or less.

7. The polyurethane foam-forming composition of claim 1, wherein the surfactant has a weight average molecular weight of from about 200 to about 2000.

8. The polyurethane foam-forming composition of claim 1, wherein the surfactant has a weight average molecular weight of from about 200 to about 1000.

9. The polyurethane foam-forming composition of claim 1, wherein the surfactant is of the formula Me₃Si(OSiMeG)₁OSiMe₃.

10. The polyurethane foam-forming composition of claim 1, wherein the G group is derived from CH₂═CHCH₂OH; CH₂═CHCH₂(OCH₂CH₂)_{y}OH; CH₂═CHCH₂(OCH₂CHCH₃)OH, or a combination of two or more thereof, where y is 1-10.

11. The polyurethane foam-forming composition of claim 1, wherein the surfactant (d) is present in an amount of from about 0.01 to about 10 pphp.

12. The polyurethane foam-forming composition of claim 1, wherein the surfactant (d) is present in an amount of from about 0.1 to about 7.5 pphp.

13. The polyurethane foam-forming composition of claim 1, wherein the surfactant (d) is present in an amount of from about 0.20 to about 5 pphp.

14. A polyurethane foam prepared from the composition of claim 1.

15. The polyurethane foam of claim 14 having a siloxane VOC and FOG emission of about 50 ppm or less.

16. The polyurethane foam of claim 14 having a siloxane VOC and FOG emission of about 25 ppm or less.

17. The polyurethane foam of claim 14 having a silxoane VOC and FOG emission of about 10 ppm or less.

18. The polyurethane foam of claim 14 having a silxoane VOC and FOG emission of about 5 ppm or less.

19. A method of preparing a flexible polyurethane foam comprising reacting a polyisocyanate with a polyol in the presence of a urethane catalyst and a surfactant, the surfactant having the formula R¹₃Si(OSiR²G)xOSiR³₃, where each R¹, R², and R³ is independently an alkyl radical having from 1 to 10 carbon atoms; G is a group having the formula —R⁴(OR⁵)_{y}A, where R⁴ is a divalent alkyl radical having from 2 to 4 carbon atoms, R⁵ is ethylene or propylene, and A is a hydroxyl group; and x is from 1 to 5; and y is from 0 to 10.

20. The method of claim 19, wherein R¹, R², and R³ are each a methyl radical.

21. The method of claim 19, wherein R⁵ is ethylene.

22. The method of claim 19, wherein R⁵ is propylene.

23. The method of claim 19, wherein y is greater than 1, and the surfactant (d) comprises at least one (OR⁵)_{y} group where R⁵ is ethylene, and at least one (OR⁵)_{y} group where R⁵ is propylene.

24. The method of claim 19, wherein the surfactant (d) has a molecular weight of about 2000 or less.

25. The method of claim 19, wherein the surfactant (d) has a molecular weight of from about 200 to about 1000.

26. The method of claim 19, wherein the surfactant (d) is present in an amount of from about 0.01 to about 10 pphp.
